(19) United States
(12) Patent Application Publication
(10) Pub. No.: US 2004/0006181 A1
(43) Pub. Date: Jan. 8, 2004

(54) Rubber thread composition, rubber thread and thread-wound golf ball

(76) Inventor: Kazuhiko Isogawa, Kobe-shi (JP)

Correspondence Address: BIRCH STEWART KOLASCH & BIRCH, PO BOX 747, FALLS CHURCH, VA, 22040-0747, US

(21) Appl. No.: 10/609,376

(22) Filed: Jul. 1, 2003

(30) Foreign Application Priority Data
Jul. 1, 2002 (JP) 2002-192075

(51) Int. Cl. C08F 8/00

(52) U.S. Cl. 525/191; 473/351

(57) ABSTRACT

A rubber thread composition contains a natural rubber and a synthetic isoprene rubber. The synthetic isoprene rubber has a cis-1,4 bond content of at least 90%, a molecular weight distribution of the synthetic isoprene rubber has only a single peak, and a ratio Mw/Mn between a weight-average molecular weight Mw of the synthetic isoprene rubber and a number-average molecular weight Mn thereof is 2.5-3.7. A rubber thread is produced by shaping the rubber thread composition into a sheet, vulcanizing the sheet and cutting the sheet into threads. A thread-wound golf ball includes a center, a thread-wound core formed by winding the rubber thread around the center, and a cover wrapping the thread-wound core.

### BACKGROUND OF THE INVENTION

1. Field of the Invention

The present invention relates to a rubber thread composition, a rubber thread and a thread-wound golf ball.

2. Description of the Background Art

Golf balls are generally classified into two categories, i.e., thread-wound golf balls having a rubber thread wound around a center which is then wrapped with a cover and solid golf balls having a core of a solid rubber wrapped with a cover. The thread-wound golf ball is superior in shot feel and controllability while the solid golf ball is superior in carry (distance) and durability.

Professional and skilled amateur golfers often use the thread-wound golf ball for its superior controllability. Ordinary-level amateur golfers, however, rarely use the thread-wound golf ball because of its inferior carry. Thus, it has been a key issue to improve the carry (impact resilience) of the thread-wound golf ball.

The above issue is addressed by, for example, Japanese Patent Laying-Open No. 55-122566 which discloses a golf ball having a rubber thread which includes, as its major components, 100 parts by mass of a natural rubber and/or cis-1,4-polyisoprene and 2-20 parts by mass of a carbon black.

Japanese Patent Laying-Open No. 61-68066 discloses a thread-wound golf ball having a rubber thread which includes a rubber component of isoprene-butadiene random copolymer with at least 80% by weight of cis-1,4 bond content.

The inventors of the present invention have found a technique by which the carry of the thread-wound golf ball can be improved while the superior shot feel thereof is maintained. Specifically, a rubber thread is wound around a center under high tension so as to form a thin rubber-thread layer, and the layer is wrapped with a thin cover. This technique, however, has a problem that the rubber thread is likely to break in the winding process of winding the rubber thread under high tension around the center. An additional problem is that the golf ball produced by this technique is likely to deform when the golf ball is repeatedly hit.

### SUMMARY OF THE INVENTION

Under the above-described circumstances, an object of the present invention is to provide a rubber thread composition, a rubber thread and a thread-wound golf ball for which occurrence of breakage of the rubber thread can be reduced in a winding process of winding the rubber thread under high tension around a center and deformation of the ball when being repeatedly hit can be reduced.

According to the present invention, a rubber thread composition contains a natural rubber and a synthetic isoprene rubber. The synthetic isoprene rubber has a cis-1,4 bond content of at least 90%, a molecular weight distribution of the synthetic isoprene rubber has only a single peak, and a ratio Mw/Mn between a weight-average molecular weight Mw of the synthetic isoprene rubber and a number-average molecular weight Mn thereof is 2.5-3.7.

Preferably, according to the present invention, a mixture ratio between the natural rubber and the synthetic isoprene rubber of the rubber thread composition is 20/80-80/20.

According to the present invention, a rubber thread is produced by shaping the rubber thread composition into a sheet, vulcanizing the sheet and cutting the sheet into threads.

Further, according to the present invention, a thread-wound golf ball includes a center, a thread-wound core formed by winding the rubber thread around the center and a cover wrapping the thread-wound core.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an exemplary molecular weight distribution of a synthetic isoprene rubber having a single peak measured by GPC.

FIG. 2 shows an exemplary molecular weight distribution of a synthetic isoprene rubber having two peaks measured by GPC.

FIG. 3 is a schematic cross-sectional view of an exemplary thread-wound golf ball according to the present invention.

### DESCRIPTION OF THE PREFERRED EMBODIMENTS

An embodiment of the present invention is hereinafter described.

[Rubber Thread Composition]

A rubber thread composition of the present invention has a rubber component which is a blended rubber of a natural rubber and a synthetic isoprene rubber. Here, the mixture ratio between the natural rubber and the synthetic isoprene rubber is preferably 20/80-80/20, more preferably 30/70-70/30 and still more preferably 40/60-60/40. If the ratio of the synthetic isoprene rubber is lower than the above-described range, a resultant golf ball has a lower impact resilience and thus the carry of the golf ball tends to decrease. If the ratio of the synthetic isoprene rubber is higher than the above-described range, breakage of the rubber thread frequently occurs in the winding process and thus there is a tendency that a resultant golf ball readily deforms when the golf ball is repeatedly hit.

The synthetic isoprene rubber has a cis-1,4 bond content of at least 90%. If the cis-1,4 bond content is lower than 90%, a resultant golf ball cannot be improved in carry due to a low impact resilience of the rubber thread. Here, the cis-1,4 bond content is measured by means of infrared absorption spectrum (Morello method).

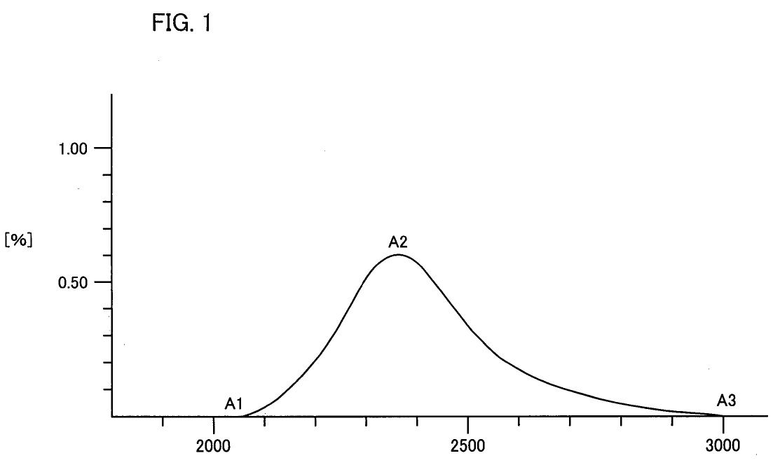

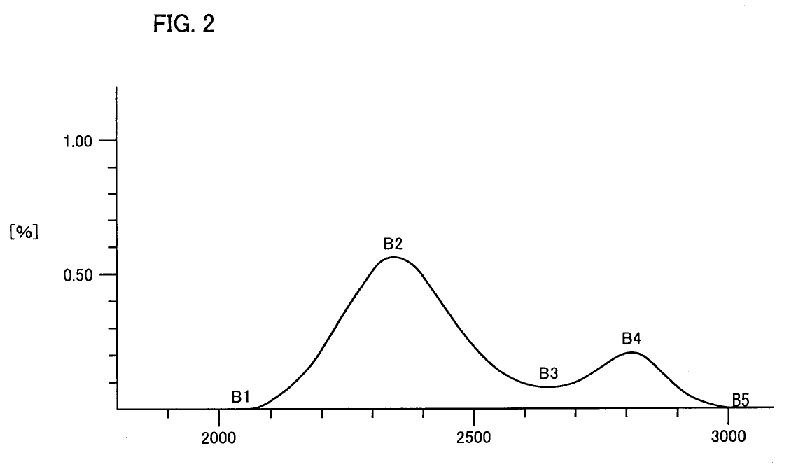

The synthetic isoprene rubber has a molecular weight distribution having only one peak, since breakage of the rubber thread more frequently occurs in the winding process if the distribution has two or more peaks. The molecular weight distribution can be measured, for example, by gel permeation chromatography (GPC). FIG. 1 shows an exemplary molecular weight distribution of the synthetic isoprene rubber having a single peak that is used by the present invention, the molecular weight distribution being measured by GPC. Here, the single peak refers to the molecular weight distribution curve in the form as shown in FIG. 1 exhibiting an increase in the direction of the vertical axis from an increase-start point A1 to a transition point A2 at which the increase is ended and a decrease starts, the decrease is ended at an end point A3, and the curve never exhibits an increase in the range between point A2 and point A3. The single peak does not refer to the molecular weight distribution curve in the form as shown in FIG. 2, for example, exhibiting an increase from a start point B1 to a transition point B2 and further exhibiting an increase from a point B3 to a point B4 before an end point B5.

The ratio Mw/Mn between a weight-average molecular weight Mw of the synthetic isoprene rubber and a number-average molecular weight Mn thereof is 2.5-3.7, preferably 2.8-3.7 and more preferably 2.8-3.6. If the ratio Mw/Mn is smaller than 2.5, breakage of the rubber thread more frequently occurs in the winding process and a resultant golf ball readily deforms when the ball is repeatedly hit. If the ratio Mw/Mn is larger than 3.7, a resultant golf ball has a lower impact resilience and the carry of the golf ball thus decreases.

Mw is preferably 1.0×10⁶-5.0×10⁶, more preferably 1.5×10⁶-4.0×10⁶ and still more preferably 2.0×10⁶-3.5×10⁶. If Mw is smaller than 1.0×10⁶, a resultant golf ball has a lower impact resilience and thus the carry of the golf ball tends to decrease. If Mw is larger than 5.0×10⁶, the workability tends to deteriorate.

Mn is preferably 5.0×10⁵-15.0×10⁵, more preferably 7.0×10⁵-13.0×10⁵ and still more preferably 8.0×10⁵-11.0×10⁵. If Mn is smaller than 5.0×10⁵, a resultant golf ball has a lower impact resilience and thus the carry of the golf ball tends to decrease. If Mn is larger than 15.0×10⁵, the workability tends to deteriorate.

The rubber thread composition of the present invention may be blended with, for example, a vulcanization accelerator, sulfur, an antioxidant and the like. The vulcanization accelerator to be used may be aldehyde-amine type, thiuram type, guanidine type, thiazole type, sulfenamide type accelerator or the like. Preferably, 0.5-5.0 parts by mass of the vulcanization accelerator is blended with respect to 100 parts by mass of the rubber component. Preferably, 0.5-7.0 parts by mass of the sulfur is blended with respect to 100 parts by mass of the rubber component. The antioxidant to be used may be, for example, phenol antioxidant like 2,2′-methylene-bis-(4-ethyl-6-t-butylphenol), amine antioxidant like N-phenyl-1-naphtylamine, or the like. Preferably, 0.5-5.0 parts by mass of the antioxidant is blended with respect to 100 parts by mass of the rubber component.

The rubber composition of the present invention is produced by mixing the rubber component, vulcanization accelerator, sulfur, antioxidant and the like with a Banbury mixer, roll or the like.

The rubber composition thus produced is vulcanized and molded into a sheet for example which is then cut into threads. In this way, a rubber thread of the present invention can be produced.

[Thread-Wound Golf Ball]

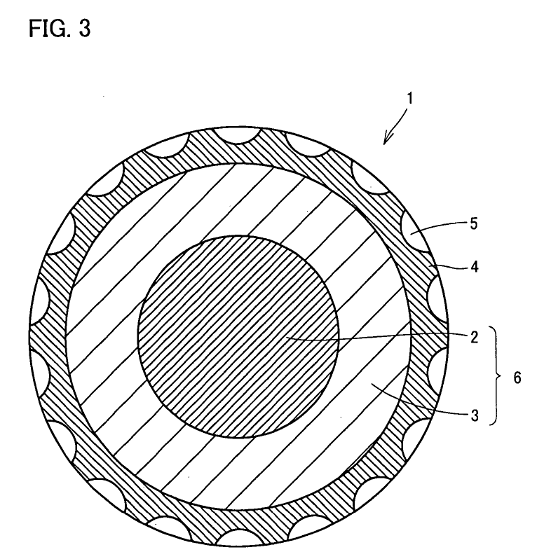

FIG. 3 shows a schematic cross-section of an exemplary thread-wound golf ball according to the present invention. Referring to FIG. 3, thread-wound golf ball 1 is constructed of a spherical center 2, a rubber-thread layer 3 of the above-described rubber thread wound around center 2 and a cover 4 enveloping rubber-thread layer 3. Center 2 and rubber-thread layer 3 constitute a thread-wound core 6 and cover 4 has dimples 5 formed therein.

Thread-wound golf ball 1 preferably has a diameter of 42.67-42.93 mm which is more preferably 42.67-42.82 mm. Preferably, thread-wound golf ball 1 under a load from 98 N to 1274 N deforms by an amount of 2.6-3.3 mm which is more preferably 2.8-3.1 mm. If the amount of deformation is less than 2.6 mm, the ball tends to feel hard at a shot. If the amount of deformation is greater than 3.3 mm, the impact resilience deteriorates and thus the carry tends to decrease.

[Center]

Center 2 is produced by a method, for example, according to which a base rubber, a co-crosslinking agent, an organic peroxide, a vulcanization adjusting agent, a filler and the like are mixed, and a resultant rubber composition to be used for the center is vulcanized and molded into the form of a sphere by press-forming or like method. In the process of the vulcanization and molding through the press-forming, a mold is charged with the rubber composition for the center, and the rubber composition is then heated under pressure usually at a temperature of 140-180° C. for 10-60 minutes. The heating in the process of vulcanization molding may be done in one stage or two stages.

The base rubber to be used is preferably high cis polybutadiene rubber, for example. Alternatively, high cis polybutadiene blended with natural rubber, polyisoprene rubber, styrene-butadiene rubber and the like may be used as the base rubber.

The co-crosslinking agent to be used may be, for example, a metal salt of α, β-unsaturated carboxylic acid, particularly a salt of α,β-unsaturated carboxylic acid with a carbon number of 3-8 like acrylic acid or methacrylic acid that is neutralized with monovalent or bivalent metal ions such as sodium, zinc and magnesium. Zinc acrylate is particularly suitable for achieving a higher impact resilience. Preferably 10-40 parts by mass of the co-crosslinking agent and more preferably 15-35 parts by mass of the co-crosslinking agent is blended with respect to 100 parts by mass of the base rubber.

The organic peroxide functions as a linking agent or curing agent. For example, dicumyl peroxide, 1,1-bis(t-butylperoxy)-3,3,5-trimethyl cyclohexane, 2,5-dimethyl-2,5-di(t-butylperoxy)hexane, di-t-butylperoxide or the like may preferably be used as the organic peroxide. Preferably 0.5-2.0 parts by mass of the organic peroxide and more preferably 0.8-1.5 parts by mass of the organic peroxide is blended with respect to 100 parts by mass of the base rubber.

The vulcanization adjusting agent to be used may preferably be an organic sulfur compound, for example, such thiophenol compounds as pentachloro thiophenol, 4-t-butylthiophenol and 2-benzamide thiophenol, such a thiocarboxylic acid compound as thiobenzoic acid, such sulfide compounds as diphenyl monosulfide, diphenyl disulfide, diphenyl polysulfide, morpholine disulfide and dixylil disulfide, or the like. Preferably 0.5-3 parts by mass of the vulcanization adjusting agent is blended with respect to 100 parts by mass of the base rubber.

The filler to be used may preferably be an inorganic salt (specifically zinc oxide, barium sulfate, calcium carbonate or the like), high-density metal powder (e.g. tungsten powder, molybdenum powder or the like) or a mixture thereof. Preferably 20-70 parts by mass of the filler and more preferably 25-60 parts by mass of the filler is blended with respect to 100 parts by mass of the base rubber.

Moreover, any usually-employed additives such as antioxidant and peptizing agent for example may be appropriately blended for center 2. Preferably 0.2-5.0 parts by mass of the antioxidant is blended with respect to 100 parts by mass of the base rubber.

Preferably, center 2 deforms by 3.3-3.9 mm in a state under a load from 98 N to 1274 N. If the amount of deformation of center 2 is smaller than 3.3 mm, the ball has a tendency to feel hard at a shot. If the deformation amount is greater than 3.9 mm, there is a tendency that the ball feels softer while the impact resilience of thread-wound golf ball 1 is not exhibited and thus a long carry cannot be achieved.

Preferably, center 2 has a diameter of 36.5-38.7 mm. If the diameter of center 2 is smaller than 36.5 mm, there is a tendency that the spin rate increases, the launch angle is almost the same as that of conventional golf balls and thus a long carry cannot be achieved. If the diameter is larger than 38.7 mm, the thickness of rubber thread layer 3 has to be made thinner in consideration of the size of thread-wound golf ball 1. Then, the rubber thread is completely wound before it is tensioned. Consequently, there is a tendency that thread-wound golf ball 1 cannot have an appropriate hardness and thus a long carry cannot be achieved.

[Rubber Thread Layer]

Rubber thread layer 3 may be formed by winding the rubber thread which is stretched by 800-1100%, for example, around center 2. Here, rubber thread layer 3 preferably has a thickness of 1.0-2.5 mm. If the thickness of rubber thread layer 3 is smaller than 1.0 mm, the impact resilience of the rubber thread layer 3 is not exhibited and thus the carry of thread-wound golf ball 1 tends to decrease. If the thickness of rubber thread layer 3 is larger than 2.5 mm, the spin rate is excessively high and thus the carry of thread-wound golf ball 1 tends to decrease.

[Cover]

Cover 4 is formed of a resin composition. As a resin component of cover 4, for example, ionomer resin or a resin mixture of ionomer resin and thermoplastic elastomer or diene block copolymer may be used. Cover 4 may contain, in addition to the above resin component, usual amounts respectively of various additives that have been known, such as a pigment of titanium oxide or the like, a dispersant, an antioxidant, a UV absorber and the like.

The surface of thread-wound core 6 may be wrapped with cover 4, for example, by a method of molding the cover resin composition into hemispherical half-shells in advance, using two such half-shells to envelope thread-wound core 6 and pressure-molding it at 120-180° C. for 1-20 minutes, or by a method of directly injection-molding the cover resin composition around the thread-wound core to envelope the core.

Cover 4 thus formed preferably has a thickness of 0.8-1.8 mm, more preferably 1.0-1.8 mm and still more preferably 1.0-1.6 mm. If the thickness of cover 4 is smaller than 0.8 mm, the spin rate is too high and thus the carry of thread-wound golf ball 1 tends to decrease. If the thickness is larger than 1.8 mm, the impact resilience of thread-wound golf ball 1 is deteriorated and thus the carry tends to be shorter.

Preferably, cover 4 has a Shore D hardness of 40-55 which is more preferably 40-52. If the Shore D hardness of cover 4 is less than 40, the spin rate increases and thus the carry of thread-wound golf ball 1 tends to decrease. If the Shore D hardness is greater than 55, the shot feel of thread-wound golf ball 1 tends to deteriorate.

Moreover, dimples 5 may be formed in the surface of cover 4 as required in the molding process of cover 4. Further, after the molding process of cover 4, cover 4 may be finished with painting, stamping and the like as required.

### EXAMPLES

The present invention is now described in conjunction with examples. The present invention, however, is not limited to them.

[Preparation of Samples]

i) Production of Center

Constituents of a center rubber composition as shown in Table 1 were mixed and then heat-pressed in a mold at 160° C. for 23 minutes thereby producing a spherical center. The content of each component in Table 1 is represented in parts by mass. Table 1 further shows diameter, mass, surface hardness, center hardness, hardness difference between the surface hardness and the center hardness and amount of deformation of the center under a load from 98 N to 1274 N.

TABLE 1

| | | center rubber |
|---|---|---|
| | | composition |
| constituent | BR-18 (*1) | 100 |
| | zinc acrylate | 28 |
| | dicumyl peroxide | 0.9 |
| | zinc oxide | 10.2 |
| | barium sulfate | 20.8 |
| | diphenyl disulfide | 0.5 |
| condition for vulcanization molding | | 160° C. × 23 min |
| property | center diameter (mm) | 37.0 |
| | center mass (g) | 32.4 |
| | surface hardness (JIS-C) | 83 |
| | center hardness (JIS-C) | 56 |
| | hardness difference (JIS-C) | 27 |
| | deformation amount under | 3.6 |
| | load 98N-1274N (mm) | |

(*1) polybutadiene manufactured by JSR Corporation

ii) Preparation of Rubber Thread

Three types of base rubber components as shown in Table 2 were dispersed in water to produce respective latexes. The latexes were mixed in such a way that the mixture ratio of solid components of respective latexes was the ratio of A-H shown in Table 2. Additives were added to and mixed with the resultant latex mixture at the ratio shown in Table 2 to prepare rubber thread compositions A-H. Rubber thread compositions A-H were each picked up by an endless belt to which a solidified liquid of an aqueous solution of calcium chloride is attached. The rubber thread composition is then solidified on the belt and a resultant gel sheet was water-washed and dried, then wound up around a drum, and vulcanized in a vulcanizer at 135° C. for 2 hours. A vulcanized rubber sheet was accordingly produced that has a width of 350 mm, a thickness of 0.5 mm and a length of approximately 100 m. The sheet was cut into strips of approximately 1.6 mm each in width. In this way, the rubber thread is produced. Here, the content of each component in Table 2 is represented in parts by mass.

TABLE 2

| | | | rubber thread compostition | | | | | | | |
|---|---|---|---|---|---|---|---|---|---|---|
| | | | A | B | C | D | E | F | G | H |
| constituent | base rubber | natural rubber | 50 | 30 | 20 | 70 | 80 | 50 | 30 | 70 |
| | | IR307 (*2) | 50 | 70 | 80 | 30 | 20 | — | — | — |
| | | IR309 (*3) | — | — | — | — | — | 50 | 70 | 30 |
| | additive | Nocceler 8 (*4) | 1 | 1 | 1 | 1 | 1 | 1 | 1 | 1 |
| | | sulfur | 2.5 | 2.5 | 2.5 | 2.5 | 2.5 | 2.5 | 2.5 | 2.5 |
| | | antioxidant (*5) | 1 | 1 | 1 | 1 | 1 | 1 | 1 | 1 |
| property | synthetic | number of peaks in | 1 | 1 | 1 | 1 | 1 | 2 | 2 | 2 |
| | isoprene | molecular weight | | | | | | | | |
| | rubber | distribution | | | | | | | | |
| | | cis-1,4 bond content | 91 | 91 | 91 | 91 | 91 | 91 | 91 | 91 |
| | | (%) | | | | | | | | |
| | | weight-average | | | | | | | | |
| | | molecular weight Mw/ | 2.97 | 2.97 | 2.97 | 2.97 | 2.97 | 1.86 | 1.86 | 1.86 |
| | | number-average | | | | | | | | |
| | | molecular weight Mn | | | | | | | | |

(*2) synthetic isoprene rubber (cis-1,4 bond content: 91%, Mw/Mn: 2.97) manufactured by Kraton Polymers Japan
(*3) synthetic isoprene rubber (cis-1,4 bond content: 91%, Mw/Mn: 1.86) manufactured by Shell Japan Ltd.
(*4) condensate of butyraldehyde-aniline manufactured by Ouchi Shinko Chemical Industrial Co., Ltd.
(*5) 2,2′-methylene-bis-(4-ethyl-6-t-butylphenol) manufactured by Yoshitomi Pharmaceutical Industries, Ltd.

iii) Production of Thread-wound Core

The rubber thread which was stretched by 1000% was wound around the center to produce a thread-wound core having the thickness of the rubber thread layer shown in Table 4.

iv) Preparation of Cover Resin Composition

Constituents of a cover resin composition shown in Table 3 were mixed by a kneading-type twin screw extruder under the conditions indicated below to produce a pelletized cover resin composition. Here, the cover resin composition was heated at the position of the die of the extruder to 200-260° C. The pelletized cover resin composition was formed into sheets each having a thickness of 2 mm, and the sheets were preserved at 23° C. for 2 weeks. At least three such sheets were stacked and the hardness of the sheet stack was measured according to ASTM-2240-68 by a Shore D spring-type hardness tester, the hardness being shown in Table 3. Here, the content of each component shown in Table 3 is represented in parts by mass.

Extruding condition

Screw diameter: 45 mm

Screw rate: 200 rpm

Screw L/D: 35

TABLE 3

| | | cover resin |
|---|---|---|
| | | composition |
| constituent | Surlyn 8945 (*6) | 30 |
| | Surlyn 9945 (*7) | 30 |
| | Epofriend A1010 (*8) | 10 |
| | Septon HG252 (*9) | 30 |
| | titanium oxide | 4 |

| | |
|---|---|
| cover hardness (Shore D) | 51 |

(*6) sodium ion neutralized ethylene-methacrylic acid copolymer ionomer resin manufactured by Dupont Co., Ltd.
(*7) zinc ion neutralized ethylene-methacrylic acid copolymer ionomer resin manufactured by Dupont Co., Ltd.
(*8) styrene-butadiene-styrene block copolymer having polybutadliene block with epoxy group manufactured by Daicel Chemical Industries Co., Ltd.
(*9) hydrogenated styrene-isoprene/butadiene-styrene block copolymer with terminal OH groups manufactured by Kuraray Co., Ltd.

v) Production of Thread-wound Golf Ball

The cover resin composition was directly injection-molded on the thread-wound core to form a cover layer having the cover thickness shown in Table 4. Then, a clear paint was applied to the surface of the cover. In this way, golf balls of Examples 1-6 as well as Comparative Examples 1-3 were produced each having a diameter of 42.8 mm and a mass of 45.4 g. Table 4 further shows a deformation amount of the golf ball in a state under a load from 98 N to 1274 N.

[Evaluation Method]

i) Breakage Count of Rubber Thread

In producing 100 thread-wound cores as discussed above, the number of times the rubber threads were broken was counted so as to evaluate the golf balls. Results are shown in Table 4.

ii) Durability

A golf club of No. 1 wood with a metal head was attached to a swing robot manufactured by True Temper. Each of the golf balls of Examples and Comparative Examples was hit at a head speed of 45 m/sec to strike the ball against a target board. Then, the number of strikes against the board before the golf ball broke or deformed was counted so as to evaluate the golf ball. Results are shown in Table 4. The durability is indicated by defining the durability of the golf ball of Example 1 as index 100. A greater index of a golf ball indicates that the golf ball is superior in durability.

iii) Carry

A golf club of No. 1 wood with a metal head was attached to a swing robot manufactured by True Temper to hit each of the golf balls of Examples and Comparative Examples at a head speed of 50 m/sec. The distance from the point where a golf ball was hit to the point where the ball landed was measured so as to evaluate the golf ball. Results are shown in Table 4.

TABLE 4

| | | | *E: Example *CE: Comparative Example | | | | | | | | |
|---|---|---|---|---|---|---|---|---|---|---|---|
| | | | E 1 | E 2 | E 3 | E 4 | E 5 | E 6 | CE 1 | CE 2 | CE 3 |
| golf ball | center diameter (mm) | | 37.0 | 37.0 | 37.0 | 37.0 | 37.0 | 37.0 | 37.0 | 37.0 | 37.0 |
| | thickness of rubber thread layer (mm) | | 1.3 | 1.6 | 1.3 | 1.3 | 1.3 | 1.3 | 1.3 | 1.3 | 1.3 |
| | rubber thread corn position | | A | A | B | C | D | E | F | G | H |
| | natural rubber/synthetic isoprene | | 50/50 | 50/50 | 30/70 | 20/80 | 70/30 | 80/20 | 50/50 | 30/70 | 70/30 |
| | rubber | | | | | | | | | | |
| | synthetic | number of peaks in | 1 | 1 | 1 | 1 | 1 | 1 | 2 | 2 | 2 |
| | isoprene | molecular weight | | | | | | | | | |
| | rubber | distribution | | | | | | | | | |
| | | cis-1,4 bond content (%) | 91 | 91 | 91 | 91 | 91 | 91 | 91 | 91 | 91 |
| | | weight-average | 2.97 | 2.97 | 2.97 | 2.97 | 2.97 | 2.97 | 1.86 | 1.86 | 1.86 |
| | | molecular weight Mw/ | | | | | | | | | |
| | | number-average | | | | | | | | | |
| | | molecular weight Mn | | | | | | | | | |

| | | | | | | | | | | |
|---|---|---|---|---|---|---|---|---|---|---|
| | thickness of cover (mm) | 1.6 | 1.3 | 1.6 | 1.6 | 1.6 | 1.6 | 1.6 | 1.6 | 1.6 |
| | diameter of ball (mm) | 42.8 | 42.8 | 42.8 | 42.8 | 42.8 | 42.8 | 42.8 | 42.8 | 42.8 |
| | mass of ball (g) | 45.4 | 45.4 | 45.4 | 45.4 | 45.4 | 45.4 | 45.4 | 45.4 | 45.4 |
| | deformation amount of ball under load | 2.9 | 2.9 | 2.9 | 2 9 | 2.9 | 2.9 | 2.9 | 2.9 | 2.9 |
| | of 98N-1274N (mm) | | | | | | | | | |
| evaluation | breakage count of rubber thread | 0 | 0 | 1 | 3 | 0 | 0 | 8 | 10 | 6 |
| | durability | 100 | 100 | 99 | 98 | 101 | 105 | 95 | 93 | 96 |
| | carry (m) | 235 | 233 | 236 | 237 | 233 | 230 | 235 | 236 | 234 |

[Results of Evaluation]

It is seen from Table 4 that all of the golf balls of Examples 1-6 exhibit a long carry, a fewer breakage count of the rubber thread in the production of the thread-wound core, and a superior golf-ball durability.

As heretofore discussed, the present invention can provide a rubber thread composition, a rubber thread and a thread-wound golf ball for which reduction of occurrence of breakage of the rubber thread in the winding process of winding the rubber thread under high tension around the center as well as reduction of deformation of the ball when repeatedly hit are achieved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A rubber thread composition containing a natural rubber and a synthetic isoprene rubber, said synthetic isoprene rubber having a cis-1,4 bond content of at least 90%, a molecular weight distribution of said synthetic isoprene rubber having only a single peak, and a ratio Mw/Mn between a weight-average molecular weight Mw of said synthetic isoprene rubber and a number-average molecular weight Mn thereof being 2.5-3.7.

2. The rubber thread composition according to claim 1, wherein
a mixture ratio between said natural rubber and said synthetic isoprene rubber is 20/80-80/20.

3. A rubber thread produced by shaping the rubber thread composition recited in claim 1 into a sheet, vulcanizing the sheet and cutting the sheet into threads.

4. A thread-wound golf ball comprising a center, a thread-wound core formed by winding the rubber thread recited in claim 3 around the center, and a cover wrapping the thread-wound core.
